(19) United States
(12) Patent Application Publication
(10) Pub. No.: US 2002/0163577 A1
(43) Pub. Date: Nov. 7, 2002

(54) Event detection in a video recording system

(75) Inventor: James Carroll Myers, Florissant, MO (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: Comtrak Technologies, Inc.

(21) Appl. No.: 09/850,518

(22) Filed: May 7, 2001

(51) Int. Cl. H04N 7/18

(52) U.S. Cl. 348/152; 348/143; 348/153; 348/154; 348/155; 348/159; 340/540; 340/541

(57) ABSTRACT

A video recording system (10) monitoring a scene to detect occurrence of an event within the scene. A camera (C1) monitors the scene and provides a video signal representative of the scene. A sensor (C2) senses movement within a portion of the observed scene and provides a signal indicative of the movement. A processor (12) connected to the camera and sensor determines if there is any movement within the scene; and if there is, the portion of the scene where it occurred based upon the signals received from the camera and sensor. The processor produces a signal indicative of the event and the portion of the scene where it occurs. A digital video recorder (18) connected to the processor now records the scene and the signal indicative of the occurrence of the event.

### CROSS-REFERENCE TO RELATED APPLICATIONS

None.

### STATEMENT REGARDING FEDERALLY SPONSORED RESEARCH OR DEVELOPMENT

Not applicable

### BACKGROUND OF THE INVENTION

This invention relates to a video recording system for a security or surveillance system, and more particularly, to a video recording system and a method for detecting an event within a scene being monitored by the system in order to record the event and to identify the event within the recording.

Security or surveillance systems may employ a camera and a video recording device to visually monitor and record a scene. The camera is located at a desired position in order to monitor a scene in a premises, facility, or building. For example, a teller's station or an ATM may be monitored to record an event such as a robbery. Although such systems are useful, one problem associated with their use is that there is no effective method of designating where an event occurred in the recording. In particular, a person may have to review an entire tape or recording in order determine where on the tape the event of interest took place. Additionally, as can be appreciated, there may be a long duration of time when nothing is occurring within a scene being monitored. In this situation, it would be advantageous to be able to discard or delete this inactivity from the recording. This becomes more important when, instead of tape, the recording is occurring in a digital format and is being stored on a hard drive. Since some systems may be limited in the amount of digital information which may be stored on a hard drive, it would be desirable to be able to identify portions of the video which have an event which should be stored and portions of the video which have no event that can be deleted. In particular, it would be desirable to continuously record a scene, determine when an event occurs within the scene, and when the storage limit is being approached be able to discard portions of the recorded data within which no event has occurred.

A video recording system of the invention uses a video camera in combination with another sensor to determine if an event has occurred within a scene of interest. A processor receives an image from the video camera and determines if the image should be saved or should be deleted at some future time. The fundamental process is to establish whether an event has occurred within a scene being monitored, and once an event has been detected or determined indicating that the data should be saved for future use or review. Processes of the type described in this application are particularly useful in security systems which record video images of scenes within a facility or building being monitored. Once it has been determined that an event has occurred, the system is capable of tagging the recorded data with an indication that the particular data should not be deleted. When reviewing the data, it is useful to be able to skip past data which does not contain an event.

Importantly, the video recording system of the invention combines video image processing to reduce or eliminate the time required to review a recording. In particular, the video recording system of the present invention uses a video camera as an imaging device or a first sensor and a passive sensor, an active sensor, or another video camera as a second sensor and processes a resulting image from the first sensor and a signal from the second sensor to determine the occurance of an event of interest within a premises or facility being monitored. A particular feature of the current invention is that there may be a plurality of additional sensors used to aid in the determination of an event occurrence such that the probability of correctly identifying events is made higher and the probability of incorrectly identifying scenes as event scenes when in fact they are not is made lower. The recorded scene or image within which an event has occurred may be identified to be able to easily retrieve the recorded scene within which the event has occurred.

### BRIEF SUMMARY OF THE INVENTION

Among the several objects of the invention may be noted the use of a video recording system and method for visually monitoring a scene and detecting the presence of an event to save the recorded event.

Another object of the invention is the provision of such a system and method to readily distinguish between general motion detection and an event detection in order to identify when the event detection occurred.

A further object of the present invention is to provide a video recording system which is programmed to save event data and delete non-event data.

Another object of the invention is the use of non-video sensors in conjuction with the video sensors to form a probability of event occurrence.

A further object of the invention is to provide event detection by use of a multi-camera configuration or system.

A still further object of the present invention is to provide a video recording system capable of distinguishing between changes within a scene caused by an event as opposed to changes within a scene not caused by the event.

Finally, it is an object of the invention is to provide a video recording system in which non-event data may be deleted or discarded in order to free up system resources.

In accordance with the invention, generally stated, a video recording system visually monitors a scene and continuously records images to digital storage. Generally, there are multiple cameras recording different portions of the premises. Images from each camera may be recorded at the same rate or each may be recording at a different rate. For example, one may be recording at 1 frame per second (fps) and another may be recording at 30 fps. It will be obvious to those skilled in the art that any such continuous recording will rapidly fill up the available recording space and that it is desirable to keep only those portions of the recorded images which have a high interest. Usually, this will correspond to some activity, such as a person approaching an automatic teller machine (ATM), a door being opened, an access card being used, or any occurrence of a change in the scene. Hereinafter, all these will be referenced simply as an event. Thus, it is desirable to record only for some time duration preceding the event and for some time duration following the event such that a record is maintained of the activity around the event.

The recording of event data may be approached in several ways. The video may be captured to disk in temporary storage subject to immediate overwriting if no event is detected (Winter, et al. U.S. Pat. No. 5,996,023). Video data may be buffered before writing to disk or playing out in order to allow time for event detection (Logan et al. U.S. Pat. No. 5,371,551; Toyoshima, U.S. Pat. No. 5,229,850). These all require a determination to be immediately made whether to record the event or delete the data. The present invention differs from these approaches in that all data is continuously recorded and the event occurrence is simply annotated such that at a later time, if required by the lack of system resources, event data may be maintained and non-event data may be discarded. Only the oldest data need be modified in this way such that a continuous record of activity may be kept for some time period in case investigation of an event necessitates the viewing of other time instances which were not classified as event times but may contain activity of interest. This also allows for the recording of events which may not be correctly identified as such and would otherwise be lost using other means.

Detection of an event is in some cases trivial and others non-trivial. Trivial cases are those for which a definite signal can be supplied to the recording system. For example, a card swipe at an ATM machine may result in the generation of an identifying number which may be passed to the recording system along with the time of the card swipe. There is thus no ambiguity in when the event occurred and the recording system can record or mark the event with confidence. However, in non-trivial cases, there is no signal which corresponds precisely to the activity of interest. For example, the event may be associated with someone approaching a teller window in a bank. Cost or appearance considerations may prohibit the placement of pressure mats, proximity sensors, and the like near the teller window. Even if they are in use, they may not reliably determine the time at which data is to be recorded. It is an object of the present invention to aid in the determination of the occurrence of an event in these nontrivial situations. This is accomplished by combining data from multiple sensors to establish a probability of event occurrence. These sensors will typically include the camera recording the scene, other cameras which view the area of interest but whose images may or may not be recorded for that area, and other passive or active sensors used to aid in the event detection.

A recording camera continually views the scene and produces a signal representative of the scene. A portion of the scene is designated as being related to an event. A processor is connected to the camera and the processor continuously records the output of the camera at a predetermined rate. The processor also determines any changes within the portion of the scene designated for event detection based upon the signals received from the camera and produces a signal indicative of an event occurring within the designated portion of the scene. Another camera is also viewing the scene and its output is routed to the same processor. A portion of the second cameras scene is also designated as relating to the same event as for the first camera. The processor determines any movement within the portion of the scene designated for event detection based upon the signals received from the camera and produces a signal indicative of an event occurring within the designated portion of the scene. A passive or active sensor such as a pressure mat is also connected to the processor. The processor outputs a signal whenever the sensor detects activity. The processor examines the signal from the sensor, the signal from the first camera, and the signal from the second camera and employs an algorithm to determine the occurrence of an event. The processor produces a signal whenever the combined inputs are determined to result from an event. This signal is sent to the recorder to mark the portion of the recording which corresponds to the event.

A method of operating the video recording system is also disclosed.

These and other objects and advantages of the present invention will become apparent after considering the following detailed specification in conjunction with the accompanying drawings, wherein:

### BRIEF DESCRIPTION OF THE DRAWINGS

FIG. 1 is a simplified block diagram of a preferred embodiment of a video recording system of the present invention;

FIG. 2 is a representation of a scene viewed by a pair of cameras of the video recording system;

FIG. 3 is a simplified representation of a file structure used in the video recording system;

FIG. 4 is a simplified block diagram of another preferred embodiment of the video recording system;

FIG. 5 is a simplified block diagram of another preferred embodiment of the video recording system;

FIG. 6 is a diagram of an interface used to program the video recording system; and,

FIG. 7 is an overlay grid of a snapshot of an image from a camera used in the video recording system with associated controls for defining an event window.

Corresponding reference characters indicate corresponding parts throughout the several views of the drawings.

### DETAILED DESCRIPTION OF THE INVENTION

Referring to the drawings, a video recording system constructed in accordance with the present invention is indicated generally 10 in FIG. 1. System 10 is used to monitor an installation such as a building or other facility and to view or observe a scene therein, detect an event such as a change occurring within the observed scene, and to trigger identification of the event if certain criteria are met. The system comprises a first camera C1 which is used to continuously monitor a scene and to produce a signal representative of the scene. Camera C1 is connected to a processor means 12 by use of a connection 14. Signals produced by camera C1 are provided from the camera, over connection 14, to processor means 12. Additionally, control signals may be sent from processor means 12 to camera C1 over connection 14. These control signals include, for example, signals which control operation or movement of camera C1 such as pan, tilt, and zoom motions. In this manner, the best possible image of the scene may be obtained.

System 10 further comprises a second camera C2 which is connected to processor means 12 via a connection 16. Camera C2 continuously monitors a portion of the scene viewed by camera C1 and camera C2 produces a signal representative of that portion of the scene. Signals produced by camera C2 are provided from this second camera to processor means 12 via connection 16. Additionally, control signals may be sent from processor means 12 to camera C2 over connection 16. Processor means 12 has a storage means 18 connected thereto by a connection 20. This storage means is used to store or record images received from cameras C1 and C2. Examples of storage means 18 include a hard drive, a tape drive, and RAM memory.

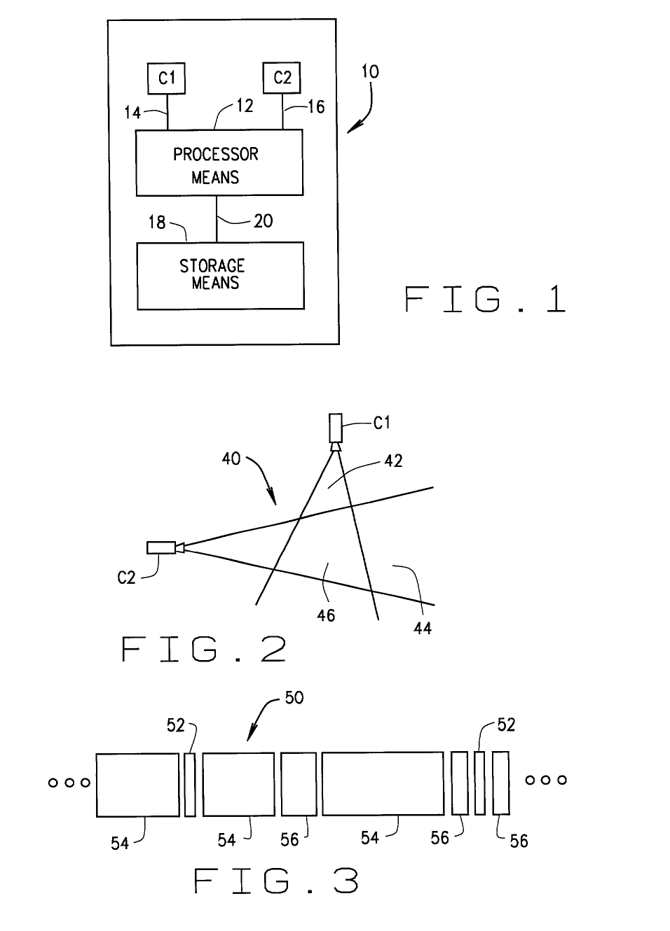

System 10 is used to distinguish between general changes occurring within the observed scene and an event whose occurrence is sufficiently significant as to be identified within the recording as to where or when the event occurred. Specifically, such an event is to be distinguished from general motion detection. To accomplish this, cameras C1 and C2 are used to establish a partial image or window of interest in which the event occurs. With reference now to FIG. 2, a scene 40 is depicted in which cameras C1 and C2 visually monitor the scene. Camera C1 has a field of view 42 and camera C2 a field of view 44. The intersection of these fields of view is designated as an area 46. Once area 46 is established, any change detected within the area is identified as an event to be recorded and saved. Changes which appear in area 46 are detected by both cameras C1 and C2 and this triggers an identification of the event. Changes occurring outside of area 46 are detected by only one of the cameras and this does not trigger or identify an event. Once an event has been detected, processor means 12 transmits a signal to storage means 18 to effectively tag that portion of the recording to indicate that an event has occurred. Additional portions of the recording may be tagged as belonging to the event which both precede the event and follow the event by defined amounts of time.

Referring to FIG. 3, a file structure 50 for digital video recording is illustrated. The structure consists of reference frames 52, non-event data frames 54, and event data frames 56. Structure 50 is used to support easy deletion of non-event data frames 54. The reference frames 52 are stored separately and the reference frames 52 may occur at any time within either non-event frames 54 or event sequence frames 56. The frames 54 and 56 are stored separately. The purpose of reference frame 52 is to reduce the amount of required storage based upon a consideration of differences between the reference frame and the subsequent frames. File structure 50 facilitates easy retrieval and deletion of data. When playback data is requested, a playback file is generated by combining reference frame 52 and its following sequence data frames 56 into a single file. Alternately, non-event sequence frames 54 may be deleted without affecting the remaining frames. In addition, the event data frames 56 may contain data from more than one event. For example, a first event may start and then stop before a predetermined time period has passed. A second event may then start also before the predetermined time period for the first event has expired. In either instance, the event data frame sequence 56 will be continuous from the time the first event begins to the time the second event ends, assuming there are no other events which occur and no intervening reference frames. By using the file structure 50, processor 12 is able to retrieve from storage means 18 event data 56 which needs to be reviewed.

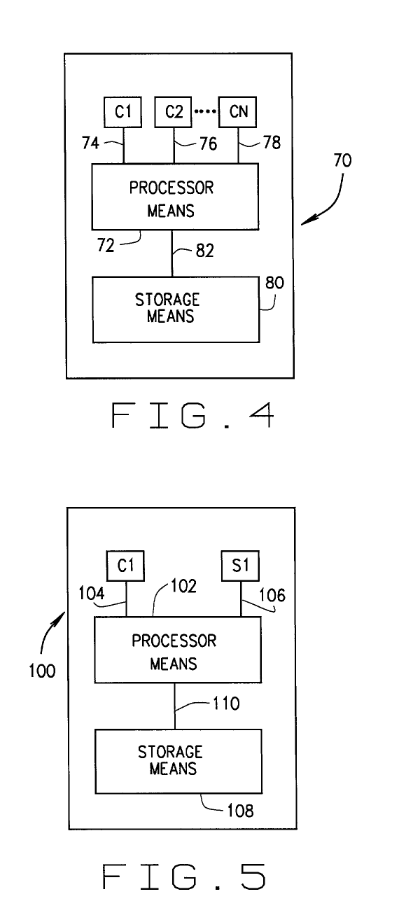

FIG. 4 illustrates another preferred embodiment of the invention which includes a video recording system indicated generally 70. System 70 comprises a plurality of cameras, C1, C2, through CN. All of the cameras C1-CN continually view a scene (or a portion of a scene) and each camera produces a signal representative of the scene being monitored. Camera C1 is connected to a processor means 72 via a connection 74. Signals representative of the scene monitored by camera C1 are provided to processor means 72 over the connection 74. In return, control signals from processor means 72 are sent to camera C1 over connection 74. Cameras C2 through CN connect to processor means 72 via connections 76 and 78, respectively; and the processor means is connected to a storage means 80 via a connection 82. Signals representative of the scene being monitored by each of the cameras C1-CN are sent to storage means 80.

System 70 is used to distinguish between general scene changes and an event in order to identify within the recording where or when the event occurred. Specifically, as indicated previously, an event is to be distinguished from general motion detection. In order to accomplish this, cameras C1-CN are used to establish a partial image or “window” of interest in which the event occurs. For example, cameras C1, C2, and CN each have a field of view and the intersection of these three fields of view defines an area of interest. Any scene changes detected within the area are identified as an event to be recorded and saved by system 70. Once an event has been detected, processor means 72 sends a signal to storage means 80 to effectively tag that portion of the recording to indicate that an event has occurred. Further, although cameras C1, C2, and CN are described as defining an area of interest, it is also possible for cameras C1 and C2 to be used to define a first area of interest, other cameras C3 and C4 (both not shown) a second area of interest, cameras C4 and C5 (both not shown) a third area of interest cameras C7 and C8 (also not shown) another area of interest; and so on, as system 70 requires Referring to FIG. 5, another preferred embodiment of the video recording system is indicated generally 100. System 100 comprises a camera C1 which is used to continuously monitor a scene and to produce a signal representative of the scene. The camera is connected to a processor means 102 by use of a connection 104 and signals produced by the camera are directed to the processor means over the connection. The system further comprises a sensor S1 which connects to the processor means via a connection 106. Sensor S1 continuously monitors or senses a portion of the scene which camera C1 is monitoring and produces a signal representative of the activation of the sensor within the portion of the scene being monitored. Signals from sensor S1 are transmitted over connection 106 to processor means 102. Examples of sensor S1 include a passive infrared detector (PIR), a smoke detector, an alarm pull, a laser beam, a motion detector, a passive sensor, or an active sensor.

Processor means 102 also connects to a storage means 108 by a connection 110. The storage means stores or records images received from camera C1. As with systems 10 and 70, system 100 is used to distinguish between general motion and an event of interest in order to identify within the recording or stored data where or when the event occurred. An event is detected by the simultaneous occurrence of scene changes detected in the images being sent by camera C1 and a signal being generated by sensor SI. The occurrence of these two signals indicates that an event is taking place within an area of interest and processor means 102 produces or generates a signal indicative of the occurrence of the event. This signal is sent by the processor means to storage means 108 to effectively tag or identify that portion of the recording to indicate that an event has occurred. Additional portions of the recording may be tagged as belonging to the event which both precede the event and follow the event by defined amounts.

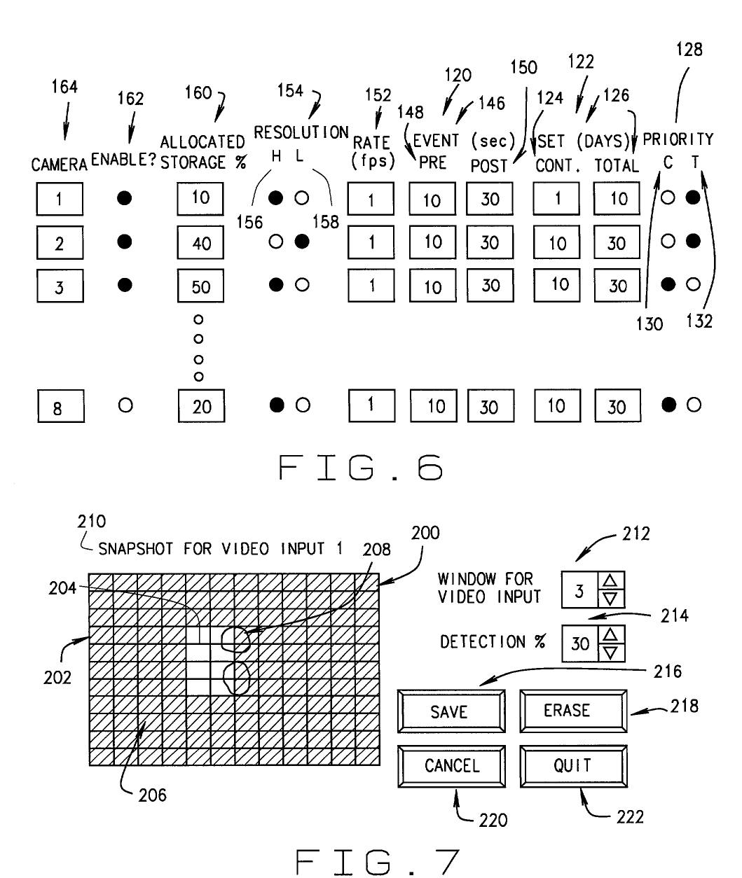

The respective storage means 18, 80, and 108 are capable of both continuous storage or recording, and event storage or recording. For example, images of a scene being monitored may be continuously recorded for a predetermined or pre-selected interval (e.g., a number of days) and after this interval expires, the recording or data is deleted. Referring in particular to FIG. 6, an interface 120 for the systems 10, 70, or 100 is illustrated. Interface 120 is used to select various options for the systems 10, 70, or 100. For purposes of the following discussion, interface 120 is described as being part of the system 70.

Interface 120 includes a column 122 labeled “Set (Days).” Column 122 includes both column 124 labeled “Cont.” and a further column 126 labeled “Total”. Column 124 is used to set the number of days of continuous storage desired and column 126 is used to set the number of days of total storage desired. The total days must equal or exceed the continuous days. This requirement is enforced by software incorporated within processor means 12 and an appropriate warning is displayed to a user of the system if an attempt is made to circumvent this requirement. A column 128 labeled “Priority” has two subcolumns 130 and 132. Sub-column 130 is labeled “C” and sub-column 132 is labeled “T”. Only one of these sub-columns is selected by the user and whichever one is selected determines the priority of storage and how system 70 determines which data to keep if either the total days or continuous days requirement cannot be met.

If sub-column 132 is selected (i.e., “set”), then event storage has priority and storage means 80 will initially record all incoming data in a continuous mode. When the allocated storage capacity of the storage means is filled, and if the days of continuous data exceeds the total days, then the oldest continuous data will be deleted to make room for new continuous data. If the continuous data is for less than the total days, some of this continuous data will be converted to event data. This is done by eliminating non-event sequence data. As new data is acquired, the boundary between continuous data and event data will keep shifting. In other words, the oldest continuous data will be converted to event data to make room for the new data. However, as long as the oldest event data is younger than the total set days, then no event data will be deleted. This process will continue even to the point where there is no continuous data, such that the maximum amount of event data is stored. In most circumstances it is expected that the total storage days will be achieved before this becomes necessary. In those instances, the oldest event data will be whatever is set in column 126. The oldest continuous data will be whatever can be achieved while maintaining the total days of data.

If column 130 is selected, then continuous storage has priority and storage means 80 will start out by recording all data in a continuous mode. When the allocated storage is filled up and if the days of continuous data exceeds the total days, then some of the oldest continuous data will be deleted to make room for new continuous data. If the continuous data is less than the total days, then some of the continuous data will be converted to event data by eliminating nonevent sequence data. As new data is acquired, the boundary between continuous data and event data again will keep shifting. That is, the oldest continuous data is now converted to event data to make room for new data. However, as long as the oldest continuous data is older than the total continuous days then no event data will be deleted. This process will continue until the oldest event data is equal to the setting in column 126, or the oldest continuous data is equal to the setting in column 124, whichever occurs first.

Consider a situation where the oldest continuous data is equal to the setting in column 124, but the oldest event data is less than the setting in column 126. Here, the oldest continuous data is converted to event data as new continuous data is added. In this case, there is always the amount of continuous data as set in the column 124. The oldest event data will be deleted as necessary to make room for the new event data derived from the continuous data. In this way, the amount of continuous data stored will always be as set in column 124. If the amount of storage allocated cannot support the setting in column 124, then all data will be continuous data and will fill the allocated capacity.

When the oldest event data is equal to the setting in column 126 and the oldest continuous data is older than the setting in column 124, the system priority is to maintain the maximum amount of continuous data while still storing the total number of days of data. Now, whenever new data is added, the oldest event data is deleted such that there is always a total number of days of storage equal to the setting in column 126. The number of days of continuous data will vary based upon the particular operating conditions of the system; but as new continuous data is added, the oldest continuous data is converted to the amount of event data needed to maintain the total days of storage equal to the setting in column 126 and while using all available storage.

If a certain number of days of continuous storage and as much total storage as possible is to be maintained, then column 130 is selected. Column 124 is now set to the desired number of days, and column 126 is set to a number that cannot be achieved.

A column 146 is labeled “Event (sec.)” and includes a first sub-column 148 labeled “Pre” and a second sub-column 150 labeled “Post”. These sub-columns provide a way in which the system user or controller can specify the amount of time allocated to each event. That is, whenever an event is detected, the resulting event recording sequence will first include frames recorded prior to the start of the event, as measured by the amount of time (in seconds) set in column 148. The sequence will also include recorded frames that follow the start of the event, again measured by the amount of time (in seconds) set in column 150. These total number of frames recorded (pre-event start and post-event start) will be kept when continuous data is converted to event data.

Interface 120 next includes a column 152 labeled “Rate (fps)” which provides a method of specifying how may frames per second are collected for each particular camera C1-CN. Another column 154 is identified by the label “Resolution”. This column includes a pair of sub-columns 156 and 158, with sub-column 156 being labeled “H” and sub-column 158 being labeled “L”. These sub-columns 156 and 158 allow the system operator to select whether storage means 80 will store data in a high quality image or “H” format, or store data in a low quality image or “L” format. Image quality relates both to image size and the appearance of the picture when replayed. For example, a setting of “H” will result in a clearer picture than a setting of “L”.

Next, a column 160 labeled “Allocated Storage %” provides for operator selection of the amount of disk space in storage means 80 which will be allocated to each enabled camera C1-CN. Another column 162 labeled “Enable?” allows the operator to turn on or off the storage for each camera C1-CN. A further column 164 is labeled “Camera”, and this column shows all of the cameras C1-CN installed and operational in system 70. While all of the cameras are listed, some cameras may not be installed or enabled, or they may currently have a problem such as being out-of-sync, having a black input, or being grayed out. Storage is still maintained and allocated for all of these cameras, even if they have a problem, but are otherwise enabled. If a camera which is enabled becomes disabled, a prompt is displayed by the system inquiring as to whether all the data for that camera should now be deleted. If the answer is yes, then storage is reallocated based on the new, now available disk space. If the answer is no, then stored data is maintained as is to allow access to the data.

Returning now to the actual operation of the system, with respect to the cameras C1-CN used in the system, they continually view or monitor a respective scene and each camera produces a signal representative or indicative of the scene. The cameras operate in the visual, infrared (IR), or ultraviolet (UV) portions of the light spectrum depending upon the application. Images provided from the cameras C1-CN may be created from the RF (radio frequency) portion of the spectrum in which instance the cameras may produce high resolution SAR images. In addition, the cameras, again depending upon the circumstances, may produce an acoustic image from the acoustic portion of the spectrum. It will be understood that while an installation will typically employ only one type of camera (black and white or color TV cameras, for example), processor means 12, 72, or 102 can process images created from a combination of all of the cameras or image sensors discussed above, even if they are employed at the same time. As use of a facility changes, for example warehouse space is changed to office space, one type camera can be replaced with another type camera without effecting the overall performance of the system and without requiring a switchover of processor means 12, 72, or 102.

For purposes of example only, the processor means 12, 72, or 102 may include a microprocessor based system having a memory means, storage means, a video monitor, an input device such as a keyboard, and other associated circuitry. The respective processor means may be constructed from off-the-shelf components as well as components custom made for a specific application, and will include appropriate software programming to control the various operations of the processor means.

Implementation of multi-camera event detection, such as system 70 provides, requires the ability to set event areas on each of the cameras C1-CN, and to assign each area to an associated event. A representative interface for doing so is shown in FIG. 7. To implement or program an event for a camera view, a snapshot of the view monitored by a camera C1-CN is taken and a grid overlay is used to assign where within the snapshot an event may take place. With particular reference now to FIG. 7, a snapshot 200 of an image from camera C1 is depicted. The corresponding video input is indicated by the caption 210. Snapshot 200 has a grid overlay 202 which is in the form of a matrix. The grid overlay conforms to the size of a macro-block for performing digital video recording change detection and compression. Initially, the entire image is grayed out in preparation for selection of event areas. The grid overlay is shown to have a selected area 204 which has been drawn using standard computer mouse movements. An area 206 outside of the selected area 204 remains shaded. Additional unshaded rectangular areas may be drawn on the grid again using the computer mouse. These areas may or may not be contiguous but all will be considered as part of the same selected area 204. The camera view C1-CN to which the drawn area(s) applies is/are selected via control 212. The amount of change of macro blocks is selected via control 214. For example, if 10 unshaded blocks are selected and assigned to video input 3, a detection % setting of 30 will cause an event indication if 3 of the macro blocks are detected as having a change in image.

Additional controls are provided to aid in the setting of the event area. A save control 216 is used to store the selected area 204 when the operator is satisfied that the event area is properly defined, the corresponding video input 212 is properly selected, and the detection percentage 214 is correct. Alternately, the operator may use an erase control 218 if it is desired to redraw the event area. Selecting this control will cause snapshot 200 to again be covered entirely in gray. The operator may cancel any current changes and revert to a previously defined event area using cancel control 220. Finally, the operator may exit the event area definition screen by using quit control 222. It will be apparent to anyone skilled in the art that additional controls may be added or the controls described may be modified and the operations performed in a different manner without substantially changing the primary object of the invention which is the ability to define separate event areas for each of a plurality of camera inputs for each camera input. For example, event areas for camera input C5 may be defined on cameras C1, C2, and C8. Event areas for camera input C7 may be defined on cameras C1, C2, and C7. The event area for each camera input may range from the entire screen to nothing. The event areas so defined may overlap one another but are independently used in the determination of an event. It will be apparent to those skilled in the art that therectangular grid system is for convenience in processing and operator interaction and is not a fundamental requirement for drawing event areas. Any arbitrary shape could be used to define event areas.

Turning now to the process of event detection, first examine an individual macro-block within a defined event area is examined. A macro-block is defined as a rectangular region within the images captured from a camera input C1 through CN. Each image is a defined size in pixels, for example, 512 horizontal pixels by 480 vertical pixels. The image is divided into rectangular subsections of pixels each 16 by 16 pixels, for example. Each subsection is defined as a macroblock resulting in a set of 960 macro-blocks. Each of these macro-blocks corresponds to a rectangular region within the grid 202 on image 200. Thus, a rectangular region in the event area is mapped directly to a macro-block on the image.

Video input is continuously received and converted to digital images. At the beginning of receiving the images and from time to time thereafter, one of the images is defined as a reference image and retained for comparison to subsequent images. This process may be the same as that used for the recording function or may be independent. For purposes of event detection, the comparison is made on a macro-block basis. That is, each macro block on the current scene is compared with the corresponding macro-block on the reference scene to determine if any changes have occurred. This may be done by counting the pixels within the macro-block whose luminance values differ from those in the corresponding reference macro block by a threshold. Another threshold may then be used such that, if the number of pixels whose luminance valued differ by the first threshold exceed the second threshold, the macro-block is declared to have changed relative to the reference. It will be apparent to one skilled in the art that other means may be used to detect changes within the macro block such as a change in color or a combination of changes in color and luminance. This may be pseudo-color in the case of radar images or thermal images. In addition, the comparison may be made to the previous image rather than a reference image. What is required is to determine that a macro-block of interest has changed in a way that is significant relative to detecting the desired event.

Each macro block within the current image is examined to determine if a significant change has occurred and each macro-block is then marked as either having changed or having not-changed. Within the image being examined, each event area for the various camera inputs is determined to have detected an event or not detected an event. For example, we may define macro-blocks in order from left to right and top to bottom in an image such that the upper left corner is macro-block 1, the upper right corner is macro-block 32, the next row of macro blocks starts on the left at macro block 33 and so on such that the last macroblock in the lower right corner is macro-block 960. Suppose, that for camera input C1, macro blocks 11 through 25 have been defined as an event area for camera input C1 and macro-blocks 16 through 35 have been defined as an event area for camera input C7. Suppose further that, for the current image, macro-blocks 16 through 20 have been declared as having detected an event whereas all the others have been declared as not having detected an event. Also suppose that the detection % for event area for camera input C1 on camera input C1 has been previously set as 25% and the detection % for event area for camera input C7 on camera input C1 has been previously set as 75%. Then an event detection will be declared for the event area for camera input C1 and an event detection will not be declared for the event area for camera input C7.

All the event area detection declarations are combined to determine the occurrence or non-occurrence of an event. For example, suppose that event areas for camera input C7 have been defined on camera inputs C1, C2, and C7. Suppose further that the current images for these inputs have been examined and that event area for camera input C7 on camera input C1 has been declared as detecting an event, event area for camera input C7 on camera input C2 has been declared as not detecting an event, and event area for camera input C7 on camera input C7 has been declared as detecting an event. For these particulars, an event will be declared as having occurred for camera input C7. The corresponding recorded images will then be marked as event images in conformance with the inputs of FIG. 6.

A general algorithm for determining if an event has occurred is as follows. Let C1-1 through C1-N be the event areas for corresponding cameras C1 through CN on camera input C1, C2-1 through C2-N be the event areas for corresponding cameras C1 through CN on camera input C2 etc. such that CN-1 through CN-N are the event areas for corresponding cameras C1 through CN on camera input CN. Further, let S1-1 through S1-N be the sensors which are assigned to camera input C1, S2-1 through S2-N be the sensors assigned to camera input C2, etc. such that SN-1 through SN-Nare the sensors assigned to camera input CN. Some sensors may be assigned to more than one camera input. Also, let E1 through EN be the declaration of an event for corresponding camera input C1 through CN and En be the current camera input as determined by the value of n. Then the following algorithm may be applied to determine if an event has occurred for camera inputs C1 through CN.

For all camera inputs C1 through CN

Set En=False

Set InputCount=0

Set EventCount=0

For all event areas

If Cni is defined

lnputCount=lnputCount+1

If Cni is an event detection

EventCount=EventCount+1

End if

End if

Next event area i from 1 through N

For all sensor inputs Sn1 through SnM

If Sni is defined

InputCount=lnputCount+1

If Sni is an event detection

EventCount=EventCount+1

End if

End if

Next sensor input i from 1 through M

If EventCount/inputCount>0.5

En=True

End if

Next Camera input n from 1 through N

The event occurrence is determined independently for each new image examined.

It will be apparent to anyone skilled in the art that other algorithms may be applied to achieve the desired result of determining the event for a particular camera input based upon a consideration of all the defined event areas and sensor inputs for that camera. In addition, the event occurrence may be made to depend on time such that the detection of the event in an individual frame must be true for at least K frames before the event is recognized for the purposes of marking the recorded video.

The process described relies on a grid overlay 202 which conforms to the macro-blocks used for recording of the digital images. It will be apparent to anyone skilled in the art that such an arrangement will reduce processing requirements but that other implementations may not use a grid overlay and may allow for any arbitrary shape to be drawn to define an event area. The same processing techniques may then be used to determine an event occurrence based on the arbitrary shape.

It is apparent that the system described may detect events whether the event detection is used for the purposes of marking a recording or is otherwise used to declare an alarm condition or otherwise to provide a signal indicative of the occurrence of the event. Thus, the event detection portion of the invention is not restricted to recording situations but may be used in any situation in which it is desired to increase the probability that an event occurrence is detected correctly.

What has been shown and described herein is an event detection and video recording system which fulfills the various objects and advantages sought therefor. It will be apparent to those skilled in the art, however, that many changes, modifications, variations, and other uses and applications of the subject video recording system are possible and contemplated. All changes, modifications, variations, and other uses and applications which do not depart from the spirit and scope of the invention are deemed to be covered by the invention, which is limited only by the claims which follow.

What is claimed is:

1. A system for visually monitoring a scene and detecting an event occurring within the scene comprising:
visual means for visually monitoring the scene and for providing a video signal representative of an image of the scene;
sensing means sensing changes within the scene and providing a signal indicative thereof; and,
processing means processing the respective signals from the visual means and the sensing means to determine if any activity occurring within the scene comprises an event, the processing means producing a signal indicative of each event occurrence.

2. The system of claim 1 further comprising storage means for recording images of the scene and signals indicative of event occurrences within the scene.

3. The system of claim 1 wherein the processing means includes means for designating an area of interest within the scene as a window with respect to which a portion of the signal received from the visual means is processed to detect if an event has occurred.

4. The system of claim 3 wherein the processing means further includes means establishing a threshold of change within the designated window for which a signal indicative of an event occurrence is produced.

5. The system of claim 4 wherein the processing means further includes means designating a threshold of change within a designated window to produce a signal indicative of a possible event occurrence when the threshold of change is exceeded.

6. The system of claim 5 wherein the processing means further includes means defining macro blocks for use in determining if the threshold of change is exceeded within the designated window, the macro blocks corresponding to macro blocks used in recording of the image, and the designated window boundaries conforming to the macro block boundaries.

7. The system of claim 2 wherein the processing means includes means identifying an interval of time preceding an event, and an interval of time following the event for associating a continuous sequence of images with the event including both the preceding and subsequent intervals of time around the event.

8. The system of claim 7 wherein the processing means includes means for varying the rate of recording of images during those portions of the recording associated with each event.

9. The system of claim 7 wherein the processing means further includes means for determining which portions of the recording to keep and which to delete, those portions of the recording being deleted being those portions with which no event is associated.

10. The system of claim 9 wherein the processing means further includes means determining a priority of recording as either a continuous portion of recording or the total time period of recording, the total time period including both continuous time recording and discontinuous time recording, continuous recording including both portions with which no event is associated and portions with which an event is associated.

12. The system of claim 11 further including means determining the designated portions to delete and the designated portions to keep based upon a priority assigned to each of continuous and total time recording.

13. The system of claim 1 wherein the visual means comprises a camera.

14. The system of claim 1 wherein the sensing means comprises either an active or a passive sensor.

15. The system of claim 14 wherein the sensor means comprises a camera.

16. A video system for monitoring a scene to detect an event occurring within the scene comprising:
first imaging means continually viewing the scene and producing a signal representative of an image of the scene;
second imaging means continually viewing a portion of the scene and producing a signal representative of an image of the portion of the scene;
processor means processing signals from the first and second imaging means to determine if an event occurs within the scene as evidenced by the simultaneous occurrence of changes within the scene and the portion of the scene, the processor means producing a signal indicative of such changes if an event occurs; and,
output means responsive to the processing means for generating a signal representative of the occurrence of each event.

17. The video system of claim 16 further including storage means for recording signals representative of images of the scene.

18. The video system of claim 17 wherein the processing means includes means for designating an area of interest within the scene as a window with respect to which a portion of the signal received from the first imaging means is processed to detect if an event has occurred.

19. The video system of claim 18 wherein the processing means further includes means establishing a threshold of change within the designated window for which a signal indicative of an event occurrence is produced.

20. The system of claim 19 wherein the processing means further includes means designating a threshold of change within a designated window to produce a signal indicative of a possible event occurrence when the threshold of change is exceeded.

21. The system of claim 20 wherein the processing means further includes means defining macro blocks for use in determining if the threshold of change is exceeded within the event window, the macro blocks corresponding to those used in recording of the image, and the event window boundaries conforming to the macro block boundaries.

22. The video system of claim 21 wherein the processing means further includes means for combining the signals indicative of a possible event occurrence to generate a composite signal indicative of the event occurrence.

23. The video system of claim 22 wherein the processing means further includes means identifying an interval of time preceding an event, and an interval of time following the event for associating a continuous sequence of images with the event including both the preceding an subsequent periods of time around the event.

24. The video system of claim 23 wherein the processing means includes means for varying the rate of recording of images during those portions of the recording associated with each event.

25. The video system of claim 23 wherein the processing means further includes means for determining which portions of the recording to keep and which to delete, those portions of the recording being deleted being those portions with which no event is associated.

26. The video system of claim 16 further including a third imaging means continually viewing a different portion of the scene than that viewed by the second imaging means, the third imaging means producing a signal representative of said different portion of the scene.

27. A method for visually monitoring a scene to detect occurrence of an event within the scene comprising:
visually monitoring the scene and providing a video signal representative of an image of the scene;
sensing a change within a portion of the scene and providing a second signal indicative of the change;
determining if any change within the scene and the portion thereof, based upon the signals, represents the occurrence of an event within the scene; and,
producing a third signal indicative of the event if it is determined that an event has occurred within the scene.

28. The method of claim 27 further including recording the images of the scene and the third signal indicative of an event occurring within the scene.

29. The method of claim 27 further including designating a portion of the video as a window to use for event detection.

30. The method of claim 29 further including using the designated window in determining an event occurrence.

31. The method of claim 30 further including designating a threshold of change within the designated window to produce the third signal when the threshold of change is exceeded.

32. The method of claim 31 further including defining macro blocks for use in determining if the threshold of change is exceeded within the designated window, the macro blocks corresponding to macro blocks used in recording the image, and the designated window boundaries corresponding to the macro block boundaries.

33. The method of claim 32 further including varying the rate of recording of images during those portions of the recording associated with an event.

34. The method of claim 28 further including determining which portions of the recording to keep and which to delete, those portions of the recording being deleted being those portions with which no event is associated.

35. A method for visually monitoring a scene for detecting the occurrence of an event within the scene comprising of:
visually monitoring the scene with a first imaging means and providing a first video signal representative of the scene;
visually monitoring the scene with a second imaging means and providing a second video signal representative of the scene;
determining the simultaneous occurrence of changes within the scene and the portion of the scene viewed by each imaging means and producing a third signal indicative of each event occurring within the scene and the portion of the scene.

36. The method of claim 35 further including designating a portion of the signal received from each of the respective imaging means for use in event detection.

37. The method of claim 35 further including designating an area of interest within the scene as a window with respect to which a portion of the signal received from the first imaging means is processed to detect if an event has occurred.

38. The method of claim 37 further including designating a threshold of change within the designated window to produce the third signal when the threshold of change is exceeded.

39. The method of claim 38 further including defining macro blocks for use in determining if the threshold of change is exceeded within the designated window, the macro blocks corresponding to macro blocks used in recording the image, and the designated window boundaries corresponding to the macro block boundaries.

40. The method of claim 39 further including combining the first and second video signals when an event occurs to produce a composite signal indicative of the event occurrence.

41. The method of claim 40 further including providing either a passive sensor or an active sensor the output of which is used in determining the occurrence of an event.

42. The method of claim 40 including providing a plurality of passive sensors or active sensors, or a combination of passive and active sensors.

43. The method of claim 35 further recording the respective first, second, and third signals.
